(19) United States
(12) Patent Application Publication
(10) Pub. No.: US 2009/0030861 A1
(43) Pub. Date: Jan. 29, 2009

(54) Probabilistic Prediction Based Artificial Intelligence Planning System

(75) Inventor: Paul Almond, Blackburn (GB)

Correspondence Address: PATWRITE LLC, 408 W. MAIN ST., MARSHALLTOWN, IA, 50158-5759, US

(73) Assignee: PAUL ALMOND LTD, Blackburn (GB)

(21) Appl. No.: 12/181,296

(22) Filed: Jul. 28, 2008

Related U.S. Application Data
(60) Provisional application No. 60/952,490, filed on Jul. 27, 2007.

(51) Int. Cl. G06E 1/00

(52) U.S. Cl. 706/21

(57) ABSTRACT

A probabilistic prediction based artificial intelligence planning system comprises at least one processing unit capable of executing a set of instructions for a probabilistic prediction and modeling system; an input means for providing an input in communication with the processing unit; an output means for providing an output in communication with the processing unit; and an evaluation function for providing a score. The score is sent to the input means. A best output function provides a best output value to the processor based on probabilistic prediction values communicated from the probabilistic prediction and modeling system. Inputs and outputs are treated exactly the same within the probabilistic prediction and modeling system. Hypothetical outputs are used to test possible states within the probabilistic prediction and modeling system and evaluated by the best output function. An undo function can reverse the effect of applying a hypothetical output.

### RELATED APPLICATIONS

This application claims priority and herein incorporates by reference U.S. provisional patent application 60/952,490, filed Jul. 27, 2007.

### BACKGROUND OF THE INVENTION

The ability to learn from the past to plan future actions and behavior is the essence of the human experience and related to intelligence. With the advent of computers, we have been able to mimic certain processes to simulate “intelligence.” This “silicon intelligence” has been applied to all kinds of situations and problems from entertainment systems, business applications, medical diagnoses etc.

Although these systems mimic intelligence, there are many problems with these systems and their ability to plan future actions are generally unreliable. There is a need for a system that provides reliable planning of future actions and future behavior based on actual and predicted data.

### SUMMARY OF THE INVENTION

A probabilistic prediction based artificial intelligence planning system comprises at least one processing unit capable of executing a set of instructions for a probabilistic prediction and modeling system; an input means for providing an input in communication with the processing unit; an output means for providing an output in communication with the processing unit; and an evaluation function for providing a score. The score is sent to the input means. A best output function provides a best output value to the processor based on probabilistic prediction values communicated from the probabilistic prediction and modeling system. Inputs and outputs are treated exactly the same within the probabilistic prediction and modeling system. Hypothetical outputs are used to test possible states within the probabilistic prediction and modeling system and evaluated by the best output function. An undo function can reverse the effect of applying a hypothetical output.

Other features and advantages of the instant invention will become apparent from the following description of the invention which refers to the accompanying drawings.

### BRIEF DESCRIPTION OF THE DRAWINGS

FIG. 1 is a system diagram of an overview of a Probabilistic Prediction Based Artificial Intelligence Planning System according to an embodiment of the present invention.

FIG. 2 is a flow chart of a main process for Probabilistic Prediction Based Artificial Intelligence Planning System according to an embodiment of the present invention.

FIG. 3 is a flow chart for finding the best output according to an embodiment of the present invention.

FIG. 4 is a system diagram illustrating the basic desirability of an output according to another embodiment of the present invention.

FIG. 5 is a system diagram depicting the desirability of an output according to yet another embodiment of the present invention.

FIG. 6 is a system diagram of an evaluation function according to an embodiment of the present invention.

FIG. 7 is a system diagram of an alternative evaluation function according to an embodiment of the present invention.

FIG. 8 is a system diagram of an overview of a Probabilistic Prediction Based Artificial Intelligence Planning System with Prioritization Control according to an embodiment of the present invention.

### DETAILED DESCRIPTION OF THE INVENTION

In the following detailed description of the invention, reference is made to the drawings in which reference numerals refer to like elements, and which are intended to show by way of illustration specific embodiments in which the invention may be practiced. It is understood that other embodiments may be utilized and that structural changes may be made without departing from the scope and spirit of the invention.

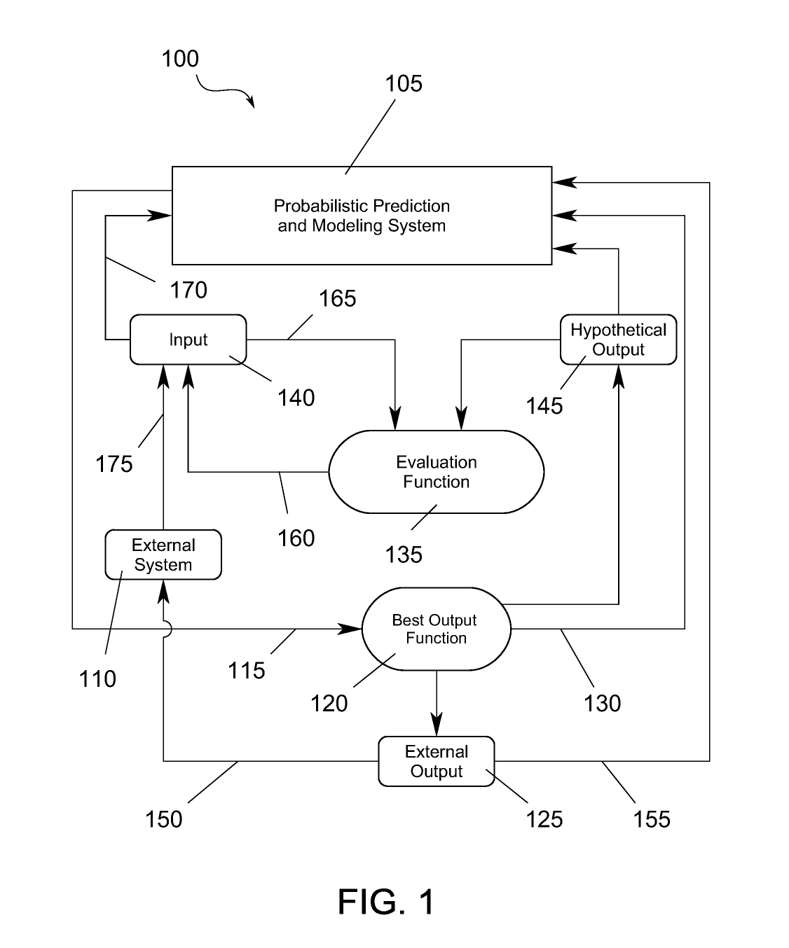

Referring to FIG. 1, an overview of a Probabilistic Prediction Based Artificial Intelligence Planning System 100 is shown as having a processing unit being adapted to run a set of instructions for a Probabilistic Prediction and Modeling System (PPMS) 105 which receives an Input Communication (IC) 170 from Input 140. Input 140 receives an External System Communication (ESC) 175 from an External System (ES) 110. PPMS 105 receives a Hypothetical Output (HO) 145, a Best Output Communication (BOC) 130 from a Best Output Function (BOF) 120 and an External Output Communication (EOC) 155 from an External Output (EO) 125.

Outputs 145, 130 and 155 are all functionally equivalent to inputs as far as PPMS 105 is concerned and no special identifiers are necessary to distinguish them from any other inputs. An Evaluation Function (EF) 135 continually examines at least one of the following: recent inputs 165, HO 145 and an External Output Communication 180 from an External Output 125 to generate a score which is communicated 160 to Input 140. When an output event is due, each possible output value is tried and PPMS 105 is informed that the output event has occurred. External Output (EO) 125 sends selected results 150 to ES 110.

External System 110 may be another computer, a digital machine such as a robotic arm or even a human interface application where data is inputted manually. Also, External Output 125 may simply be a signal, code, or an actual output such as display information, etc. as is known in the art.

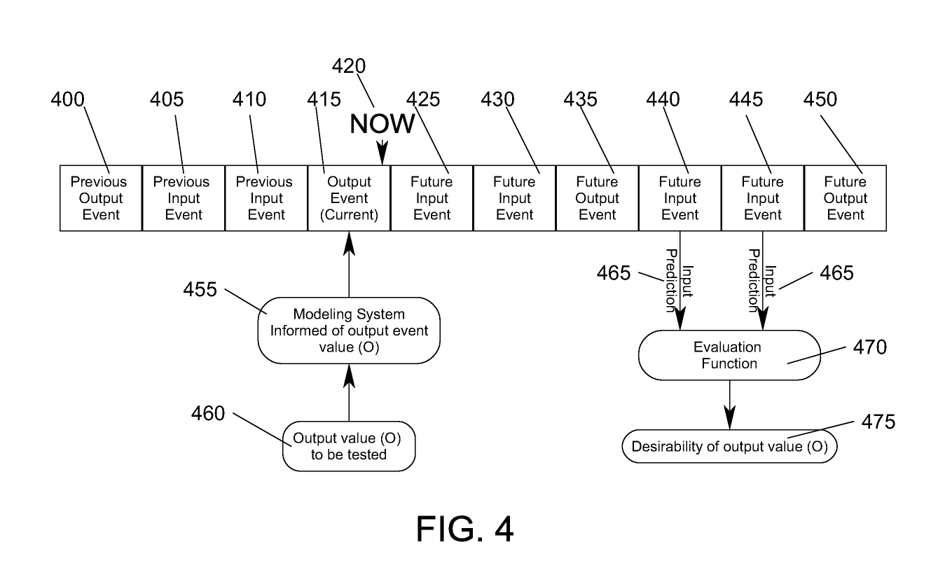

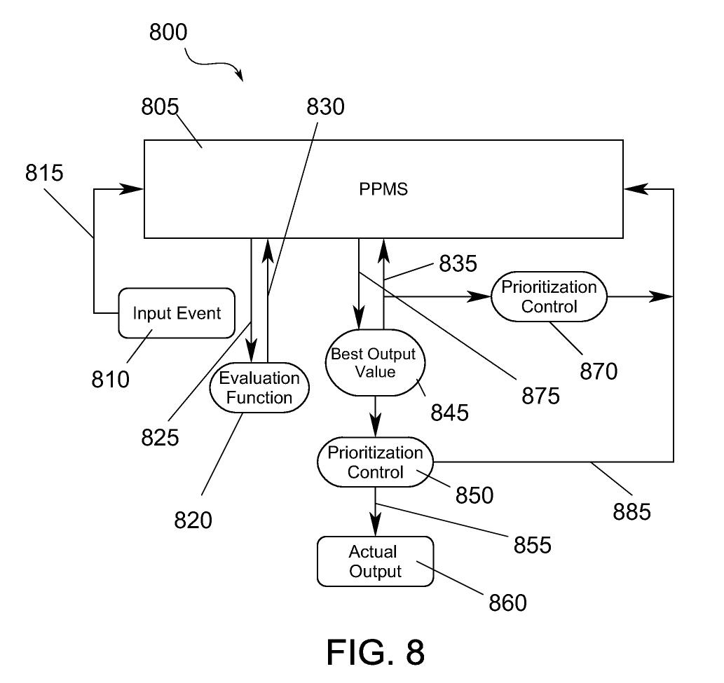

Referring to FIG. 8, an overview of Probabilistic Prediction Based Artificial Intelligence Planning System 800 is shown as having a processing unit being adapted to run a set of instructions for a Probabilistic Prediction and Modeling System (PPMS) 805 which receives an input event 810 which is transmitted 815 to PPMS 805 which is informed of input event 810, a Best Output Value 845 and a Prioritization Control Output 885 which are used internally to make probabilistic predictions of future events. An evaluation function 820 continually examines recent inputs 825; in one embodiment outputs are examined as well, and generates a score 830 which is also sent to PPMS 805 as if it were an input. When an output event is due, each possible output value is tried and PPMS 805 is informed that the output event has occurred with a value 835. If the output event is for a prioritization control output 870, then Best Output Value 845 is also sent to PPMS 805 as a prioritization control instruction 885. For each output value, a probabilistic prediction of a future input of evaluation function 820 is requested 875 from PPMS 805, allowing the desirability (see FIGS. 4 & 5) of the output value to be assessed. Best output value 845 is selected as the output and is either sent 855 to the outside world as a conventional output 860 or if the event is a prioritization control output, then the output value is sent to PPMS 805 as a priority control instruction 885.

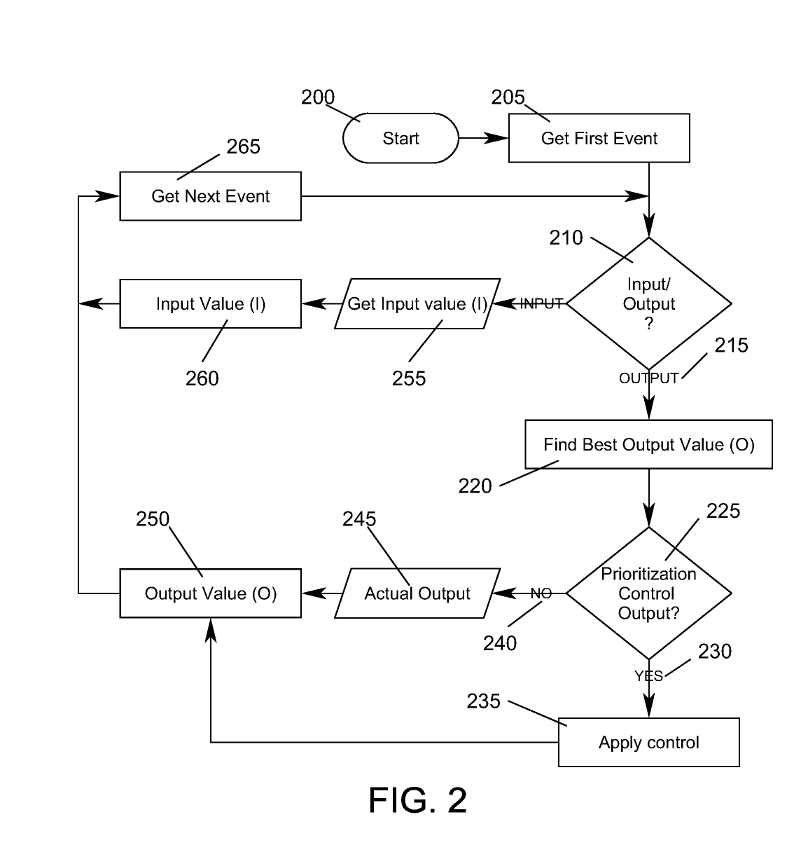

Referring now to FIGS. 2 and 8, a flowchart is used to describe the main process. A start command is issued 200 which triggers the Get First Event 205 instruction to the decision block 210 which determines whether the event is an input or output event. If the event 205 is an input event, it is sent to Get Input Value (I) 255 which informs PPMS 805 that the event has occurred with an input value (I) 260. This triggers a Get Next Event 265 instruction which is fed back to decision block 210 in a loop. If the event is determined to be an output event 215, the Find Best Output Value routine 220 finds the best output value (O) and passes output value (O) to a Prioritization Control Output Decision Block 225 which determines whether output value (O) is a prioritization control output. If output value (O) is not a prioritization control output 240 then output value (O) is sent to an actual output 245 and PPMS 805 is informed 250 that the event has occurred with output value (O). If the output event (O) is determined to be a prioritization control output (O) 230, then modeling system 105 is informed 250 that the event has occurred with output value (O). The process is repeated as long as desired.

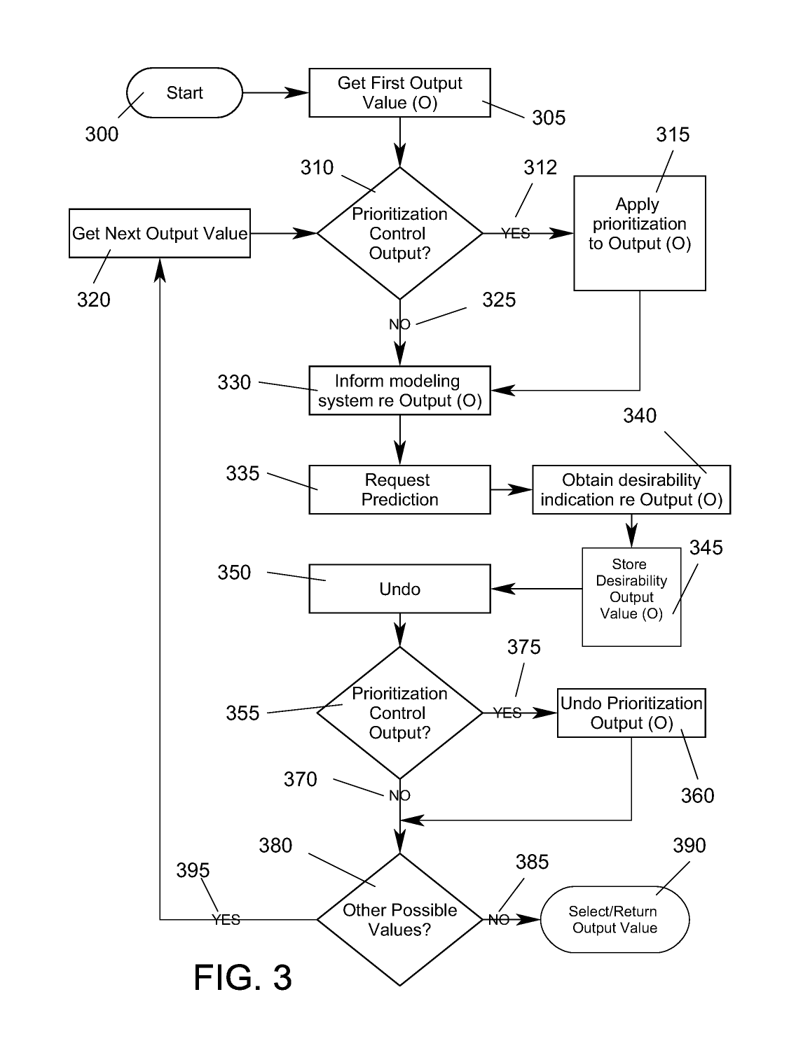

Referring now to FIGS. 3 & 8, a flow chart illustrating a Find Best Output routine according to an embodiment begins with a start command 300 issued to get a first possible output value (O) 305. Output value (O) is passed to decision block 310 which determines whether output value (O) is a prioritization control output. If Yes 312, prioritization control output (O) is applied 315 to PPMS 805 and informed 330 that the event has occurred with output value (O) which in turn causes a request to be issued for a prediction of a future input 335 which is used to encode an evaluation function score. Next request function 335 is used to obtain an indication of the desirability of output value (O) 340 from prediction 335. The desirability of output value (O) is stored 345 and may be used to Undo 350 informing PPMS 805 that the event occurred which is then fed to a decision box 355 for prioritization control output decision. If yes 375, then an Undo application routine result 360 is sent to PPMS 805 and then passes to decision box 380 which analyzes whether there are any more possible output values to process. If decision box 355 concludes that the output is not a prioritization control output, then this result is fed to decision box 380 as discussed above. If there are no more possible output values to process 385, then a best output value is returned 390. If there are more possible output values to run 395, then this information is fed back to the get next output value (O) step 320 and the process reiterates as many times as desired.

With reference to FIGS. 4 and 8, the basic desirability of an output is illustrated as comprising a Previous Output Event 400, Previous Input Event 405, Previous Input Event 410, Output Event (Current Event) 415, Future Input Event 425, Future Input Event 430, Future Output Event 435, Future Input Event 440, Future Input Event 445 and another Future Output Event 450. The present is represented by the NOW position 420 within Output Event 415. Future Input Events 440 and 445 respectively lead to Input Predictions 465 which is processed by Evaluation Function 470 leading to a score representing the Desirability of Output Value (O) 475. Output Value (O) is tested 460 by informing 455 PPMS 805 that Output Event (O) has occurred.

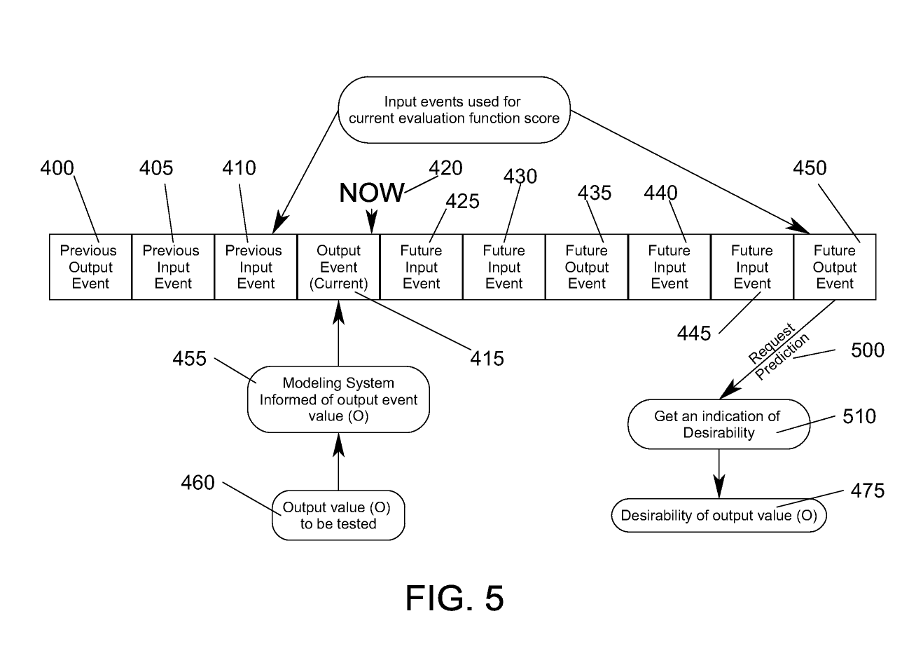

Referring now to FIGS. 4 and 5, Previous Event 410 and Future Input Event 450 are used as input for a current evaluation score. Evaluation Function Score Prediction is requested 500 and leads to an indication of desirability 510 which can be related to an expected evaluation function score which produces desirability output value (O) 475.

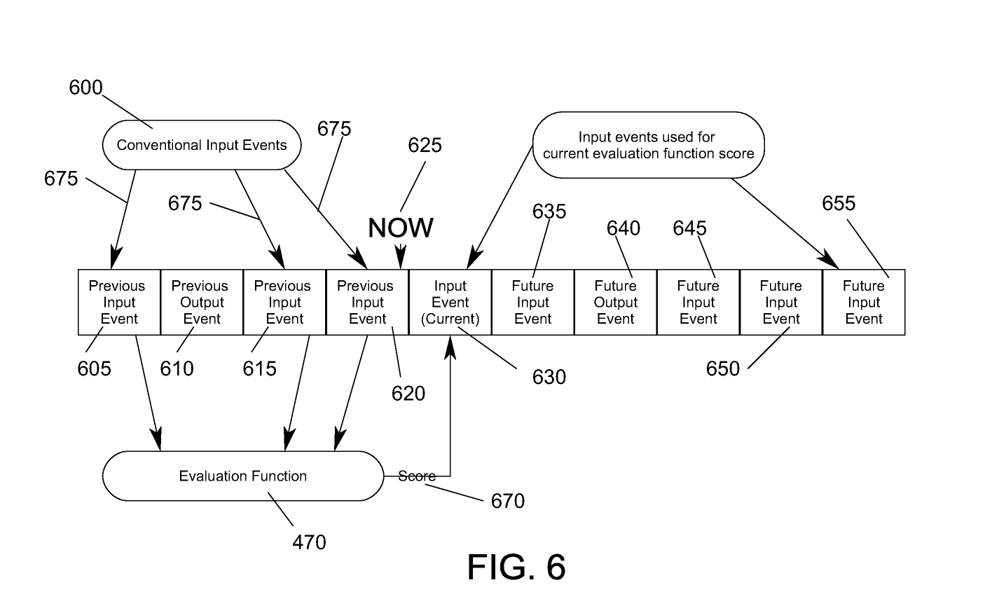

FIG. 6 is a system diagram of Evaluation Function 470 and comprises at least one conventional input event 675 fed to previous input event 605, 615 and/or 620 respectively which are used by Evaluation function 470 to produce a score 670 which is fed to Input event (current event) 630 with the present represented by NOW 625. Input event 630 and future input event 655 will be used as input for the current evaluation function score 670.

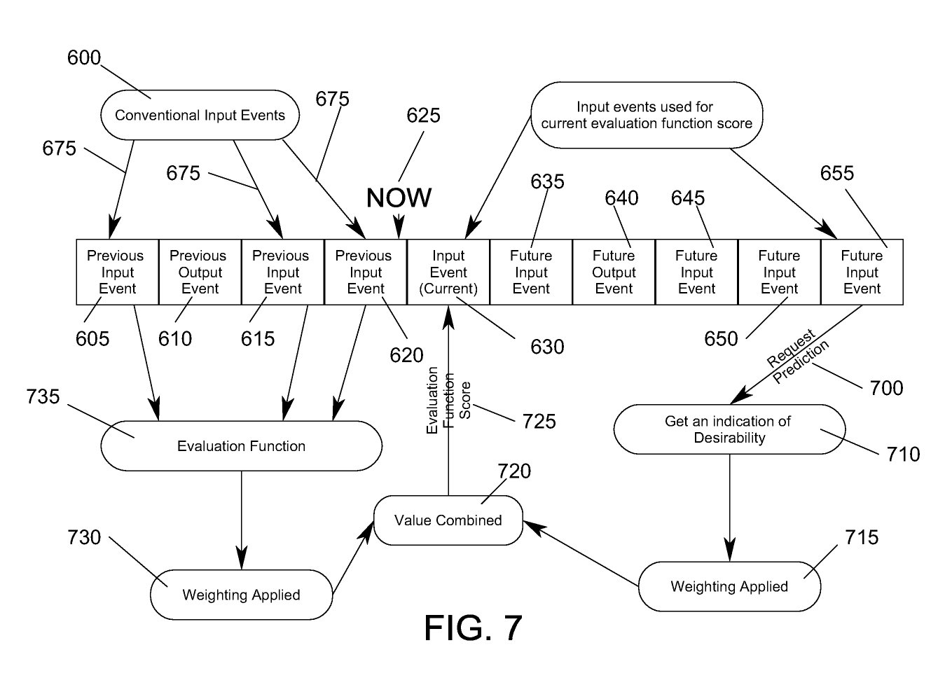

An alternative evaluation function is depicted in FIG. 7 where a conventional evaluation function 735 has a weighting applied 730 and fed to combiner 720. A request evaluation function score prediction 700 leads to an indication of desirability (i.e. expected evaluation function score) 710 and then a weighting is applied 715 and fed to combiner 720. Combiner 720 produces an evaluation function score 725.

Probabilistic Prediction Based Artificial Intelligence Planning System uses an AI modeling system to perform both modeling and planning without the need for a separate planning system. Probabilistic Prediction Based Artificial Intelligence Planning System also uses prioritization control outputs—special pseudo-outputs generated by the system—in the same way as any other outputs, but instead of acting on the external world, these outputs act on the modeling system as instructions to control prioritization of its use of computing resources.

Inputs and outputs of the modeling system are considered in terms of input and output events. An input or output event is the occurrence of an input or output at some instance with a specific value. Inputs and outputs may take the value of “0” or “1” but other values are possible. History to the modeling system is a sequence of input and output events.

The modeling system observes past input and output events of the modeling system and makes probabilistic predictions of the values for future input and output events. The modeling system is predicting what will happen in reality and in its own behavior. The Probabilistic Prediction Based Artificial Intelligence Planning System makes no distinction between its' own outputs and other outputs and treats them in exactly the same as any other input about which a prediction may be made. The lack of distinction between inputs and outputs within the modeling system is total although other routines could be used to identify a self input/output if it were needed. Ordinarily the system has no special feature for representing itself or modeling its own behavior when predicting its own future output. It does not need to know that along with modeling its future observations, it's modeling its own behavior. In Probabilistic Prediction Based Artificial Intelligence Planning System, self modeling is an inevitable result of a system observing its own inputs.

When an input or output event occurs, the event value becomes known and the modeling system is informed about its occurrence and its value. The modeling system is therefore continually informed about input and output events that occurred. The modeling system is not restricted to being informed about input and output events that have actually happened. Hypothetical data can be generated and used as input and output for the system

All embodiments require computing resources to be prioritized since resources are considered finite. The modeling system decides what input data is most relevant to generate probabilistic predictions while conserving resources.

The evaluation function returns a score indicating the desirability of the situation described by a given state of the model. It does not deal with any abstraction in the model. The evaluation function examines previous inputs and outputs—most likely recent ones—to determine the present state. In one embodiment, the modeling system may provide the history of input and output event values and in an another embodiment it may maintain separate data structures, containing the information derived from previous input and output events to provide information to the evaluation function. Of course this information could be stored outside of the modeling system itself but it would need to be updated by the model.

The evaluation function score is continually computed and encoded as one or more inputs for the modeling system. The AI system continually observes its own evaluation function score. In this way, the modeling system can provide probabilistic predictions for future inputs of the evaluation function score. This means that predicting the future desirability of its situation given the current state of the model is enabled and a natural part of the process. Of course it is also possible to simply request probabilities of future input values from the modeling system and then determining their desirability as would be apparent to one skilled in the art.

When an input event occurs, the relevant input value is received by the modeling system and the system is informed of the occurrence of the input event and its value. In addition to conventional inputs, the evaluation function score is continually evaluated and input events are generated and then the modeling system is informed of the occurrence. When one or more input events relate to the evaluation function score, the evaluation function score is computed by the evaluation function and that score is used to determine the values of these input events.

When an output event occurs, the modeling system selects an optimum value by trying each possible value in turn with the system determining the desirability of the output event occurring with that value. For each output tried, the modeling system is informed that the event has occurred and the value associated with its occurrence. In the case where the event is a prioritization control output, the output also acts on the modeling system and is sent as a prioritization control instruction. The modeling system is requested to provide a probabilistic prediction for an input event or events that will be used to encode a future value for the evaluation function occurring with different possible values. The probability values allow the mean (expected) value for the evaluation function score to be calculated. The mean value for the evaluation function score is an indication of the desirability of the output value being tried. The higher the expected evaluation function score, the greater the output value's desirability.

The modeling system calculates the expected future value of the evaluation function by requesting a prediction of the expected value of one of the future inputs that will be used to input the score. No special process is involved and is simply a natural function of the processes internal to the system. Of course other statistical manipulations would be acceptable as long as there is at least some relationship between the expected score such as median score, or other modal statistic or even some complex routine. It might be of interest to track a “lowest score” or some other criteria such as minimum standards for example. The user can define the criterion that meets a particular need. Additionally, it is not essential that the modeling system check every possible output value. Methods such as interval bisection could be used to direct the system to concentrate on areas of interest by telling the system whether to look higher or lower. These alternatives would be apparent to one skilled in the art and contribute to the flexibility of the modeling system.

The evaluation function score is likely to have a wide range of possible values and could be a real number or an abstraction.

Probabilistic Prediction Based Artificial Intelligence Planning System allows the AI system to learn sophisticated behavior. This learning occurs within the modeling system. The learning occurs as follows:

1. The system initially lacks previous input or output events. All probabilistic prediction values produced by the system give no information about its future, e.g. the probabilities for any binary inputs and outputs would be 0.5. The system's behavior is arbitrary as there is nothing on which to base predictions.

2. After some input and output events occur, the modeling system has observed enough events to predict future events. This includes predicting of input events used for encoding of the evaluation function score. The system is able to make meaningful, probabilistic predictions of what will happen (including its own behavior) after an output is made so that the future evaluation score following the output can be probabilistically predicted. Although the system's predictions will assume arbitrary behavior by itself, the desirability of different outputs can be meaningfully determined and desirable, non-arbitrary outputs are selected and made for each output event.

3. As desirable outputs are made, the modeling system is informed about their occurrence so that its experience of input and output events now starts to include desirable output events.

4. When the modeling system is used to predict the consequences of further outputs, the system's predictions no longer assume that the output is followed by other, arbitrary outputs. The system now has a history of more desirable behaviors and will base its predictions of its own behavior following the output being considered on this. Each output is now being evaluated based on how it fits into the expected future behavior of the system—which is now improving—to produce a future evaluation function score. This leads to better selection of outputs and improves the system's behavior.

5. The outputs from the previous step, resulting from a better selection process, in turn becomes part of the history of input and output events about which the model has been informed. This improved behavior starts to form the basis for predicting the behavior following further outputs, leading to even further improvements etc.

6. The improvement which the system can achieve goes beyond this. Because the gradual improvement in the system's behavior has itself become a feature of the history of the output of events that have been observed by the modeling system and the system will start predicting improvement in its own behavior within this context in a process that is reminiscent of compound interest. Ultimately this process is only limited by the available computing resources. When the system reaches this state, it is possible to run the system for some time with most of the processing taking place within the modeling system itself. This is based on the system's established behavior and modeling future behavior based on the same standard. It might be necessary to introduce stability functions to deal with small unavoidable errors that gradually accumulate when iterative processes are executed within devices. Any small error such as a rounded value feed forward and the cumulative effect of all these errors can cause such a system to veer far from the desired result. The Probabilistic Prediction Based Artificial Intelligence Planning System ensures that these errors are fixed automatically if left running.

Referring again to figures, each of the processes discussed may be run on a single machine such as a personal computer, supercomputer, massively parallel computer, or other digital device suitable for running a set up program instructions. It is also possible that each subroutine be run on separate machines interconnected through a network such as the Internet. Continuous connection is not required as long as each component could communicate at selected intervals. In this way it is not necessary to have the components physically next to each other. Additionally, the processes described in this application need not be run on a digital device only but may be implemented in any device capable of repeatedly executing a given control code such as an analog, quantum or other computing device.

Probabilistic Prediction Based Artificial Intelligence Planning System approach to planning in artificial intelligence (AI) uses the AI system's modeling system to produce probabilistic predictions of future behavior that are equivalent to planning of future behavior.

The purpose of the modeling system is to use information about past input events and output events to make probabilistic predictions of future input events and output events.

The modeling system is informed of input events and output events as they occur: when an input event or output event occurs the modeling system is informed of its value.

The modeling system can be asked to provide a probabilistic prediction for a specific future input event or output event. Predictions can be expressed in a number of ways. For now we will assume that obtaining a prediction means asking the modeling system for the probability that a given future input event or output event will occur with a given value.

Prioritization Control Outputs

Why Prioritization Control is Needed

However the modeling system is constructed, its computing resources need prioritizing. The modeling system will need to decide what input data is most relevant in generating the probabilistic predictions of inputs and outputs and which of many possible computations are most relevant. Some computations will be based on intermediate results and the decision about which intermediate results to use could be complex. All of these decisions may vary from time to time and the modeling system needs to adapt the way it computes accordingly.

The modeling system needs to think only about relevant things.

This issue of keeping a computing system “focused” is often known as the carpet texture problem.

Some way is needed of controlling prioritization of computing resources in the modeling system—what it concentrates on—at any time.

How Prioritization Control Outputs Work

Some of the AI system's outputs are designated as special prioritization control outputs. Prioritization control outputs do not control events in the outside world. Instead, they control prioritization of computational resources within the modeling system.

Apart from what they control, prioritization control outputs are dealt with in the same way as other outputs:

There is no special planning involving them—the method that will be used to generate other outputs (described shortly) will also generate prioritization control outputs.

They are observed by the modeling system along with the other, conventional outputs, so that the modeling system can use them in making its predictive model.

This means that the AI system is making outputs to control its own modeling system just as it would manipulate its outside environment. In a way, the modeling system becomes part of the outside environment, an idea which I called AI as a boundary system. Prioritization control outputs will affect the way that the modeling system “focuses” its computing resources and will influence the degree of uncertainty in its predictions. If a probability close to 0 or 1 is returned for a future event then there is little uncertainty in the prediction, but with a value close to 0.5 there is more uncertainty. The purpose of prioritization control is to manage what the modeling system focuses on so that the events of most interest are predicted with as little uncertainty as possible.

The modeling system is not restricted to being informed about input and output events that have actually happened: it can also be informed hypothetically. The modeling system can be made to simulate hypothetical futures by informing it about input and output events that have not yet occurred, using possible future values for these events.

Use of the modeling system for simulation necessitates the capability of restoring it to previous states: if we hypothetically inform the modeling system that a particular input or output event has occurred with a given value then we need to be able to “rewind” the modeling system later to a previous state before it was informed of this.

This is equivalent to the way in which the state of a chess board is dealt with in chess programs. In chess programs a tree search simulates possible future moves but the board is not permanently altered.

One way of achieving this is to have an “undo” facility which reverses the effects of the most recent act of informing the modeling system about an input or output event and, if the event is a prioritization control output, also reverses the effects of applying it to the modeling system as a prioritization control instruction.

The Situational Evaluation Function

The situational evaluation function has some similarity with positional evaluation functions in chess algorithms and returns a score indicating the desirability of a situation described by a given state of the model. It does not need to deal with any abstraction in the model. The situational evaluation function examines previous inputs (and possibly outputs)—most likely very recent ones—to determine what sort of situation the AI system is in. The modeling system, being informed of input and output events as they occur can provide this data. The modeling system may provide only the history of input and event values or it may maintain separate data structures, containing information derived from previous input and output events, to provide information to the situational evaluation function. This information could also be stored outside the modeling system, but it would need updating with the model. Whether it is part of the modeling system depends on the definition of the system.

At any instant of time, for a real or hypothetical situation, there is a specific value for the situational evaluation function score that would be obtained for applying the situational evaluation function for that situation.

Situational Evaluation Function Score as an Input for the AI System

The situational evaluation function score is continually computed and encoded as one or more inputs for the AI system. That is to say, the AI system continually observes its own situational evaluation function score. These observations of the situational evaluation function score are input events so they are observed by the modeling system: it is informed about them as they happen in the same way it is informed about other inputs. This means that the modeling system can be requested to provide probabilistic predictions for future input of the situational evaluation function score. This means that the modeling system predicts the future desirability of its situation given the current state of the model.

The Process

Probabilistic Prediction Based Artificial Intelligence Planning System is intended to determine the optimum output to make at any given time. A sequence of input events and output events will occur over time and each will need to be dealt with.

Input Events

When an input event occurs, the relevant input value is received by the AI system and the modeling system is informed of the occurrence of the input event and its value.

As well as conventional inputs, the situation function score is continually evaluated and input events are generated and sent to the modeling system.

When one or more input events relate to the situational evaluation function score—these will occur frequently—the situational evaluation function score is computed by the situational evaluation function and the score used to determine the values of these input events.

Output Events

When an output event occurs, Probabilistic Prediction Based Artificial Intelligence Planning System selects the optimum value for it as follows:

Each possible value for the output event is tried in turn and the modeling system is used to determine the desirability of the output event occurring with that value.

For each output value being tried, the modeling system is informed that the output event has occurred with that value to simulate its occurrence. In the case of a prioritization control output, the output also acts on the modeling system: that is it is sent to as a prioritization control instruction. When requested, the modeling system provides probabilistic predictions for input event or events that will be used to encode a future value for the situational evaluation function occurring with their different possible values. These probability values allow the mean (expected) value for the situational evaluation function score that will be used to make this input or inputs to be calculated. The mean (expected) value for the situational evaluation function score is an indication of the desirability of the output value being tried: the higher the expected situational evaluation function score, the greater the output value's desirability. The act of informing the modeling system about the output event occurring with the value that was just tried is then undone and, if the output was a prioritization control output, the act of sending the output to the modeling system as a prioritization control instruction is also undone. The process is then repeated for the next possible value of the output event.

For the output event being considered, the output will actually occur with the value which was found most desirable. The output is actually made with that output value. For a conventional output this means that it acts on the external world. For a prioritization control output this means that the output acts on the modeling system: that is it is sent to it as a prioritization control instruction. The modeling system is informed that the output event has occurred with that value. Processing then moves to the next input or output event.

Encoding the Situational Evaluation Function Score as Inputs.

The situation evaluation function score is likely to have a wide range of possible values and could be a real number with the number of possible values depending only on the precision with which computers represent real numbers. If the modeling system is used with input events and output events with small numbers of possible values, then this means that multiple input events may be used to encode the situational evaluation function score. In one embodiment, a weighted system is used so that the values for some input events are more significant than others and redundancy is used so that more input events than are necessary may be used.

### DIFFERENT EMBODIMENTS FOR PROVIDING PROBABILISTIC PREDICTIONS

The method as it has been described involves each input event or output event having a specific value, which is known for past input and output events but not future ones. For future input or out events the modeling system is requested to provide probabilistic predictions in the form of probabilities for the different values of an input event or output event, but this is not the only way in which probabilistic predictions could be presented.

The most obvious use of predictions of future events is to obtain information about a future value of the situational evaluation function score to evaluate making an output. This information is extracted from the modeling system by asking it in turn for the probability that the relevant input event takes each possible value, but there could be a large range of values. The modeling system is instead requested to provide the probability that the value for a particular input event or output event will be within a given range of values. A number of different probabilities are then obtained from the modeling system for different ranges, allowing the mean (expected) situational evaluation function score to be calculated.

Although the mean (expected) situational evaluation function score is an obvious choice for evaluating the desirability of the possible future consequences of an output, it is not the only choice. Other statistical result could be used instead as is known in the art. The median or modal values could be used, or some result obtained in a more complex way. If the AI system's role is safety critical, for example, the desirability may be measured in terms of the probability that the situational evaluation function score is not below a certain value.

Rather than providing actual probabilities which are used to compute the mean (expected) value, or some other statistical result for an event, the modeling system may directly provide such a statistical result on request.

In general, whatever result is provided from the modeling system as a probabilistic prediction for a particular input event or output event will be derived from the expected frequency distribution over the different possible values for the input event or output event. The results provided merely need to be compatible with whatever method is used to extract a prediction of future desirability from the input event(s).

Uncertainty in the Predicted Situational Evaluation Function Score.

A prioritization control output could make a particular course of action seem better than another by causing more uncertainty in the predictions of inputs corresponding to the situational evaluation function. This should automatically be dealt with to some extent by the ability of the system to find better courses of action when uncertainty is low: this idea of “obtaining a better view” is discussed later. If necessary, it is explicitly dealt with by adjusting predictions of expected situational evaluation function scores (or whatever values indicate desirability) according to how much uncertainty they have, so that more certain expected scores are favored to some degree.

When to Take the Situational Evaluation Function Score.

An output value is tested by asking the modeling system for a prediction of a situational evaluation function score in the future. There is the issue of how far in the future this prediction should be. This may be variable. It may be a small number of events (or a short time) in the future in the early stages, and further into the future in later stages.

Predictions for a number of situational evaluation function scores, for different times in the future, may be used and then averaged or combined in some other way.

Informing the Model and Applying Prioritization Control.

In the case of a prioritization control output, trying a possible output value, or using the output value that is ultimately selected, involves two processes: applying the output as a prioritization control instruction and informing the modeling system that the output event has occurred. The order of these processes is not ultimately critical. If the occurrence of the output event with a particular value is to be undone, however, it is desirable to undo each of these in the reverse order in which they occurred: for example, if the prioritization control output was applied to the modeling system as a prioritization control instruction before the modeling system was informed about the output event then it is logical to undo the act of informing the model about the output event before undoing the application of the prioritization control output to the modeling system.

Why Probabilistic Prediction Based Artificial Intelligence Planning System Process Works and how the system learns sophisticated behavior.

Probabilistic Prediction Based Artificial Intelligence Planning System allows the AI system to learn sophisticated behavior. This learning occurs within the modeling system.

The system initially lacks previous input or output events. All the probabilistic prediction values produced by the system give no information about its future, e.g. the probabilities for any binary inputs and outputs would all be 0.5. The system's behavior is arbitrary as there is nothing on which to base it.

After some input and output events have occurred the modeling system has observed enough input and output events to predict future input and output events. This includes the predicting of input events used for encoding of the situational evaluation function score. The system is able to make meaningful, probabilistic predictions of what will happen (including its own behavior) after an output is made so that the future situational evaluation score following the output can be probabilistically predicted. Although the system's predictions of the future will assume arbitrary behavior by itself, the desirability of different outputs can be meaningfully determined and desirable, non-arbitrary outputs are now selected and made for each output event.

As these desirable outputs are made, the modeling system is informed about their occurrence, so that its' experience of input events and output events now starts to include desirable output events.

When the modeling system is used to predict the consequences of a further output, the modeling system's predictions will no longer assume that the output is followed by other, arbitrary outputs. The system now has a history of more desirable behavior and the modeling system will base its predictions of its own behavior following the output being considered on this. Each output is now being evaluated based on how it fits into the expected future behavior of the system—which has now been improving—to produce a future situational evaluation function score. This leads to better selection of outputs and an improvement in the system's behavior.

The outputs in the previous step, which result from a better selection process, in turn become part of the history of input and output events about which the model has been informed, meaning that this improved behavior will start to form the basis for predicting the behavior following further outputs, leading to further improvement, and so on.

The improvement which the process can achieve goes beyond this. The process so far has leads to gradual improvement in the system's behavior but this improvement itself is a feature of the history of output events that have been observed by the modeling system. The modeling system will therefore start predicting improvement in the system's behavior and later outputs will be assessed within this context.

This process is ultimately limited only by the computing resources available to the modeling system. When the system reaches this stage it would actually be possible to run the system for some time without most of the processing outside the modeling system, instead just using for each output the most likely output predicted by the modeling system. This would be based on the idea that the system's established behavior would already be as competent as it is going to be and modeling its future behavior from this behavior should provide the same standard of behavior. A problem with doing this, however, is that small, unavoidable errors would gradually accumulate and the model would randomly drift away from its competent behavior. In the long term, therefore, it is necessary to introduce a stabilizing function to ensure that outputs are tested against the situational evaluation function in some way.

The modeling system is doing the planning.

The modeling system's predictions of the AI system's future behavior are directing its future behavior.

Planning is prediction.

Why Prioritization Control Outputs Work.

Prioritization control outputs resolve the issue of how the system learns how to adjust the internal prioritization in its modeling system. It learns how to do this in the same way that it learns how to plan any other aspect of its behavior. Prioritization control outputs that inappropriately set priorities in the modeling system will cause it to spend its limited computing resources wrongly and work in a sub-optimally, with too much uncertainty in areas where more certainty was needed. This happens for various reasons:

All of the probabilistic predictions of inputs and outputs have a lot of uncertainty because processing has been wasted on computing intermediate results that have little effect on these predictions.

Processing has been wasted on achieving an unnecessarily high standard of prediction for a small fraction of those input and output events that are of interest.

Processing is being wasted on achieving a high standard of prediction for irrelevant input and output events.

If the modeling system operates within these parameters; it is inefficient. The system will encounter a lot of uncertainty and will be unable to plan well enough to achieve high situational evaluation function scores. If, however, the system produces behavior with better prioritization then the model predictions will have less uncertainty for those inputs and outputs where it matters and the system will be able to achieve high situational evaluation function scores.

When the system tries prioritization control outputs that result in simulations by the modeling system with too much uncertainty to get good situational evaluation function scores, and also tries prioritization control outputs that result in simulations with less uncertainty that do allow it to achieve good scores, the prioritization control outputs that reduce uncertainty in useful ways will be found to be better and will be selected by the processing external to the modeling system. The modeling system does not need to “know” that it is doing this by using the prioritization control outputs: in fact, it does not need to know which of its outputs are prioritization control ones and which are conventional. In this way, the prioritization control outputs made by the system are slightly “nudged” in the direction of better modeling. Once made, these prioritization control outputs are part of the system's behavioral history and will naturally play a part in the predictions of future behavior made by the modeling system. In this way, the system learns to organize itself.

Planning need not be simple.

Using previous behavior as a guide does not mean the modeling system is merely expected to generate future behavior by simplistically copying previous behavior. Basing future behavior on previous behavior means basing it on a model generated from past behavior. The relationship between past and future outputs is merely that they are part of the same model: this model can have any degree of sophistication supported by available processing power.

Far from demanding that the system simply copy old behavior, this actually allows it to improve its behavior. If the past behavior shows a history of the system's performance in some task improving, and if the system has observed enough inputs and outputs, then the most obvious model is one predicting further improvement for the system.

Identifying Events

Whatever semantics is used by programmers in software outside the modeling system, it is not necessary for the modeling system to differentiate between events corresponding to inputs, outputs, prioritization control outputs or the situational evaluation function score. From the point of view of the modeling system's internal workings these are all viewed as events, the values of which the system is informed when they occur and about which probabilistic predictions are made based on previous events.

Although the modeling system does not need to distinguish between types of events, the processing outside the modeling system does: for example when a prediction of a future input of the situational evaluation function score is requested, there needs to be some way of ensuring that this is what is requested and not a prediction of some other kind other event. One way that this can be done is to relate the sequencing of events to their type. For example, every 20,017th event could be a particular type of input event.

When requesting predictions, the relevant future events may be identified with sequence numbers or times (relative to the current event or the present). In addition, information identifying different types of events may be passed to the model. For example, the modeling system could be informed that a particular event has occurred corresponding to input of a pixel at particular coordinates from a camera, or the modeling system could be asked to provide a probabilistic prediction for the 10,028th occurrence (after the current event) of a particular type of input event used to encode part of the situational evaluation function score.

Whether or not the modeling system is informed of the type of event, it does not need to know what any of the different types of event mean. The modeling system may be informed about an “output” event, but this just means that it is given some code to identify the event as being of the same type as other output events. Other codes could identify other types of event but none of these codes mean anything to the modeling system: ideas such as “input event” or “output event” have no meaning inside the modeling system. Prioritization control outputs are, of course, applied to the modeling system in a special way to adjust its internal workings, but from the point of view of the modeling system being informed about them, they are just like any other event: the modeling system has no “understanding” of which, of all the events about which it is informed, correspond to its prioritization control outputs. If the modeling system is told about the types of events then this is equivalent to having separate “channels” containing numbers and the modeling system is expected to make probabilistic predictions of the future contents of these channels based on what has been observed in them previously. If the type of event is not communicated to the modeling system then this equivalent to having a single channel where the sequencing of different types of event is important.

In saying that the modeling system does not need to distinguish between different types of event, it is not true that the modeling system cannot distinguish between them. Clearly, to make predictions the model has to take into account the types of event in order that the relationships between them can be determined. This does not need to be a feature of the computer code or hardware used to implement the modeling system, however, and is instead an emergent property of the information—the model—produced by the modeling system's internal workings.

General Comments on the System

Planning is Prediction

Because the modeling system generates predictions, and actually does most of the system's planning, then we conclude that planning is really prediction. The modeling system is doing the planning.

Though it may seem strange, this is natural. In everyday life we have a good idea, from modeling, what other people will do next. If modeling can tell us what someone will do next, it follows that the person being modeled could also know what he/she is going to do next, given access to the same kind of modeling—making a good case that this is how people determine what to do next.

We are used to thinking of “making your mind up” as determining the optimum actions to make, given some model. In the context of the present invention, it means something different. When you have not “made your mind up” about something you lack sufficient information to predict your actions with regard to it. When you experience the “making up of your mind” it means that you now have enough information in your model to predict what you are going to do.

The Link Between the Model and Desirability

How is the system supposed to “know” to improve itself if its behavior is based on modeling from its previous behavior? This “direction” to the system's behavior is given by the processing outside the modeling system—the situational evaluation function in particular—which does test possible outputs according to desirability. The situational evaluation function can be considered a link between the modeling system (which is doing the real planning) and the way that desirability of inputs is defined.

Prioritization Control and Integrity

We could fallaciously ask how, if the prioritization control outputs are all wrong, as they must be initially, we can know that use of the modeling system in simulations will cause low scores. If the modeling system is not working properly, what would stop it wrongly making predictions giving high scores and suggesting that the incorrect prioritization control outputs are good? This fallacy would be based on the idea that the prioritization control outputs control everything in the modeling system. This is not the case. Prioritization control outputs do not affect the integrity of the modeling system at all. The integrity of the modeling system must always be assured irrespective of what the prioritization control outputs are. The prioritization control outputs do control how the modeling system spends its computing resources and which aspects of the modeling are done in detail and which are represented by abstraction.

The Importance of Prioritization Control

Although the modeling system needs to ensure that the model has integrity without prioritization control, this does not mean that prioritization control has a minor role of “fine-tuning” a modeling system. Setting up the prioritization in a modeling system is a critical part of making the model itself.

For example, the simplest modeling system with integrity in a system with binary inputs and outputs could just spew out the same probability for each value of a future input or output event value which has two possibilities. Such a system may have integrity, but there is nothing there. A more sophisticated modeling system lacking any kind of prioritization control may attempt to analyze everything. It would not get very far though: time constraints imposed by the need to act in the real world would limit such computation and the computation that did get done would be almost arbitrarily. By trying to analyze everything, such a modeling system would analyze almost nothing.

Obtaining a “Better View”

The following analogy gives an idea of how prioritization control outputs work, and shows why they need no special type of learning:

Imagine a robot which uses Probabilistic Prediction Based Artificial Intelligence Planning System. It is capable of planning actions in the world—of manipulating the world to improve its situational evaluation function scores. Suppose there are easily-moveable obstacles blocking the robot's view, and what is behind them may be relevant to the robot's situation. We should not be surprised if the robot moves the obstacles. Doing so could reduce uncertainty in some aspect of its future predictions, allowing it to chart a path through these predictions that improves its score.

Suppose that after moving the obstacles the robot sees a computer scientist who offers to make some improvement to its modeling system. The robot should not need any special type of behavior to evaluate this offer. If the scientist's claim is correct, accepting the offer would involve making outputs that result in the system having better probabilistic predictions—just like the decision to move the obstacles.

In both moving the obstacles and accepting the scientist's offer the AI system is simply making outputs that give it a “better view”. Whether this “better view” is achieved through making outputs that just alter the environment or making outputs that alter the modeling system in ways that allow better scores to be achieved is irrelevant.

Instead of the scientist we can now imagine the robot finding a tool kit and making the alterations to its own modeling system by itself and we can take this further. Ultimately, we are left with certain outputs that directly affect prioritization within the model system.

This gives a simple view of prioritization control outputs: as do-it-yourself brain surgery.

While specific details of how prioritization control outputs work within the modeling system need to be decided for any specific modeling system used, prioritization control outputs are the general way in which the carpet texture problem should be solved.

Prioritization Control, Irreversibility and Forgetting

There is no reason, in principle, why prioritization outputs should not be able to make irreversible changes to the modeling system, provided that these do not compromise its integrity; for example, prioritization outputs could order some detailed information in the modeling system to be replaced by abstraction. It should be noted that “irreversible” does not mean that changes made to the model cannot be undone by software external to the modeling system.

This is relevant with regard to the issue of storage of the historical data about past input and output events in the modeling system. Explicit storage of all this historical data—that is to say, storing the value of every input and output event—could require a lot of storage capacity and a greater problem may be that storage of this data will mean that it gets processed, potentially using a lot of the system's resources. It is unlikely that the human brain explicitly stores all the historical data in this way. Such abstraction can be directed by prioritization control outputs which replace detailed historical data by abstracted versions of it when the benefits of abstraction in terms of reduced storage capacity requirements and processing outweigh any loss of accuracy in prediction. This would be forgetting. It would be valid for prioritization control outputs to do this provided that the integrity of the modeling system remained intact.

If the modeling system is caused to “forget” parts of the historical record of input and output events like this, the prioritization control outputs causing it are planned within the modeling system itself: forgetting is not being imposed from outside, but rather the modeling system is itself determining what it needs to forget as part of Probabilistic Prediction Based Artificial Intelligence Planning System.

Self-Modeling as an Emergent Property

In an alternative embodiment the desirability of a future situation is determined by requesting the system explicitly to provide probabilistic predictions of conventional future inputs and (possibly) future outputs having various values at some time in the future. The situational evaluation function would then be applied to this data to generate the score and indicate the desirability.

Undoing Changes to the Model

In an embodiment utilizing an “undo” facility, reversing the act of informing the modeling system about the occurrence of an input or output event and the application of a prioritization control output to the model may be accomplished using a single undo facility or separate undo facilities could be used.

Another embodiment makes a copy of the model before it is informed about the event and before any prioritization control output is applied, so that there are now two copies of the model, inform one of these about the event and then discard it when simulation of the event has ended, reverting to the unaltered copy of the model.

Use of a Directed History

The system's response to inputs is based on modeling of previous inputs and outputs. It requires a history of desirable behavior to establish a pattern of desirable behavior which modeling will continue or, which is better, a history of improvement in behavior to establish a pattern of improvement in behavior which modeling will continue.

Although the instant invention has been described in relation to particular embodiments thereof, many other variations and modifications and other uses will become apparent to those skilled in the art.

What is claimed is:

1. A probabilistic prediction based artificial intelligence planning system comprising:
at least one processing unit capable of executing a set of instructions for a probabilistic prediction and modeling system;
an input means for providing an input in communication with said at least one processing unit;
an output means for providing an output in communication with said at least one processing unit;
an evaluation function for providing a score wherein said score is communicated to said input means; and
a best output function for providing a best output value to said at least one processor based on probabilistic prediction values communicated from said probabilistic prediction and modeling system.

2. The probabilistic prediction based artificial intelligence planning system according to claim 1 wherein said output means includes a hypothetical output based on said best output function.

3. The probabilistic prediction based artificial intelligence planning system according to claim 1 further comprising an external system in communication with said input means.

4. The probabilistic prediction based artificial intelligence planning system according to claim 3 further comprising an external output means in communication with said best output function for providing output to said probabilistic prediction and modeling system and said external system.

5. The probabilistic prediction based artificial intelligence planning system according to claim 4 wherein said external output means is also in communication with said evaluation function.

6. The probabilistic prediction based artificial intelligence planning system according to claim 4 wherein said evaluation function is adapted to receive said hypothetical output for use in calculating said score.

7. The probabilistic prediction based artificial intelligence planning system according to claim 5 wherein said evaluation function receives data from at least one of said input means, said hypothetical output and said external output means for use in calculating said score.

8. The probabilistic prediction based artificial intelligence planning system according to claim 6, wherein said evaluation function continuously examines data from at least one of said input means, said hypothetical output and said external output means to produce said score which is fed back to said input means.

9. The probabilistic prediction based artificial intelligence planning system according to claim 3 wherein said external output means is fed back to said external system.

10. The Probabilistic Prediction Based Artificial Intelligence Planning System in AI system according to claim 8 further comprising an undo function for undoing a previous result.

11. The probabilistic prediction based artificial intelligence planning system according to claim 9 wherein said best output function determines whether a selected output is fed as said hypothetical output or to said external output means.

12. The probabilistic prediction based artificial intelligence planning system according to claim 11 wherein said external output means comprises a visual display.

13. The probabilistic prediction based artificial intelligence planning system according to claim 11 wherein said external output means comprises at least one other processing unit.

14. The probabilistic prediction based artificial intelligence planning system according to claim 11 wherein said input means comprises a keyboard.

15. The probabilistic prediction based artificial intelligence planning system according to claim 11 further comprising a prioritization control output function in communication with said best output function.

16. The probabilistic prediction based artificial intelligence planning system according to claim 1 wherein said evaluation function receives data from said hypothetical output and said external output means for use in calculating said score wherein said score is used to determine the desirability of a particular output in said best output function.

17. The probabilistic prediction based artificial intelligence planning system according to claim 1 wherein said evaluation function receives data only from said hypothetical output for use in calculating said score.

18. The probabilistic prediction based artificial intelligence planning system according to claim 1 wherein said best output function is adapted to perform a tree search; a hypothetical output being made at each node wherein said probabilistic prediction and modeling system is notified therein.

19. The probabilistic prediction based artificial intelligence planning system according to claim 1 wherein said probabilistic prediction based modeling system does not differentiate between inputs and outputs wherein both are processed as indistinguishable events.

20. A method for probabilistic prediction based artificial intelligence planning, the method comprising the steps of:
inputting an event to a probabilistic prediction and modeling system having a best output function and an evaluation function therein;
repeating step 1 until there are no more input events scheduled and the next event is an output event.
generating a hypothetical output event within said best output function having an output value;
inputting said output value to said probabilistic prediction and modeling system;
requesting a prediction from said probabilistic prediction and modeling system of a future input corresponding to a future input of said evaluation function;
sending said prediction to said best output function wherein said prediction is used by said best output function to determine the desirability of an outcome occurring with that value;
repeating from step 3 until all possible output values have been tried for that output.
displaying a best output based on selected criteria; and
repeating from step 1 if further inputs and outputs need processing.
